(19) United States
(12) Patent Application Publication
(10) Pub. No.: US 2005/0134689 A1
(43) Pub. Date: Jun. 23, 2005

(54) Image processing system

(75) Inventor: Koji Hatanaka, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/007,522

(22) Filed: Dec. 7, 2004

(30) Foreign Application Priority Data
Dec. 17, 2003 (JP) 2003-419360

(51) Int. Cl. H04N 5/225

(52) U.S. Cl. 348/207.1

(57) ABSTRACT

An image processing system includes a playback unit for playing back an image recorded on a recording medium, a communication unit for transmitting the image played back by the playback unit to an external information processing system via a transmission pathway, an operation unit including a plurality of operation keys, and a control unit for switching a transmission mode among a plurality of modes including a first mode in which transmission of the image according to an operation of the operation unit is enabled and a second mode in which transmission of the image according to an operation of the operation unit is disabled. The control unit changes the transmission mode to the first mode according to a predetermined operation of the operation unit in the second mode.

### BACKGROUND OF THE INVENTION

1. Field of the Invention

The present invention relates to image processing systems, and in particular to an image processing system that can transmit image data to an external information processing system.

2. Description of the Related Art

Digital cameras for recording captured image data on a memory card are known, as described in Japanese Patent Laid-Open No. 2003-111002. In such digital cameras, image data recorded in a memory card is often transmitted to a computer to save and/or process the image data therein. For this purpose, a digital camera is generally connected to a computer, where host application software is started up to import an image recorded on the memory card to the computer.

The digital camera connected to a computer (hereinafter, referred to as a PC) has two principal modes.

In one mode, a user interface (hereinafter, referred to as a UI) of the digital camera is enabled. In this mode, the UI of the digital camera is operated to, for example, transfer images to the computer.

In the other mode, the UI of the digital camera is disabled. In this mode, the digital camera is accessed with an application running on the computer and the UI of the application is operated to import images from the digital camera to the computer.

In the mode where the UI of the digital camera is enabled, if, for example, an image is deleted by operating the camera or by accessing the digital camera with the host application running on the computer, processing for preventing data inconsistency, that is, processing for data synchronization or exclusive processing on data, is required. Because the operation by the digital camera and the operation by the computer are available in parallel in this case.

On the other hand, the mode where the UI of the digital camera is disabled is problematic in that a useful feature such as the ability to transfer an image specified after the image has been confirmed on the screen of the digital camera is not available due to the disabled UI of the digital camera. In this case, once the mode of the disabled camera UI is selected, there is no way of easily switching to the other mode as described above with satisfying the data synchronization or the exclusive processing.

### SUMMARY OF THE INVENTION

The present invention is directed to solve the above-described problems.

Among other advantages, the present invention can enable image data to be transmitted by a simple UI operation, and to prevent image data inconsistency between the camera and the computer.

According to an aspect of the present invention, an image processing system includes a playback unit for playing back an image recorded on a recording medium; a communication unit for transmitting the image played back by the playback unit to an external information processing system via a transmission pathway; an operation unit including a plurality of operation keys; and a control unit for switching a transmission mode among a plurality of modes including a first mode in which transmission of the image according to an operation of the operation unit is enabled and a second mode in which transmission of the image according to an operation of the operation unit is disabled. The control unit changes the transmission mode to the first mode according to a predetermined operation of the operation unit in the second mode.

According to another aspect of the present invention, an image processing system includes an imaging system having a first mode in which transmission of an image recorded on a recording medium by an operation of an operation unit is enabled and a second mode in which transmission of the image by an operation of the operation unit is disabled, and capable of transmitting an image recorded on the recording medium via a transmission pathway; and a computer connected to the imaging system via the transmission pathway, the computer receiving the transmitted image to display the transmitted image on a display device and the computer having a first status in which processing of the image recorded on the recording medium by operating a user interface is enabled and a second status in which processing of the image by operating the user interface is disabled. If a predetermined operation is performed by the operation unit while the imaging system is in the second mode and the computer is in the first status, the imaging system switches from the second mode to the first mode and the computer switches from the first status to the second status.

According to still another aspect of the present invention, a data processing system includes a communication unit for receiving an image on a recording medium via a transmission pathway, the image being played back by an external image processing system having a first mode in which transmission of the image according to an operation of an operation unit is enabled and a second mode in which transmission of the image according to an operation of the operation unit is disabled; a display unit for displaying the image on a display device, the image being received via the communication unit; a user interface for specifying processing of the image recorded on the recording medium; and a control unit for switching an operation status between a first status in which processing of the image recorded on the recording medium by an operation of the user interface is enabled and a second status in which processing of the image according to an operation of the user interface is disabled. The control unit sets the image processing system to the second mode by transmitting a control command via the communication unit if the operation status is the first status, and the control unit switches the operation status from the first status to the second status and changes the image processing system to the first mode by outputting a control command to the image processing system via the communication unit if a predetermined operation is performed on the user interface in the first status.

According to still another aspect of the present invention, a data processing method includes the steps of displaying an image on a display device, the image being received by a communication unit for receiving the image on a recording medium via a transmission pathway, the image being played back by an external image processing system having a first mode in which transmission of the image according to an operation of an operation unit is enabled and a second mode in which transmission of the image according to an operation of the operation unit is disabled; and switching an operation status between a first status in which processing of the image recorded on the recording medium by an operation of a user interface for specifying processing of the image recorded on the recording medium is enabled and a second status in which processing of the image according to an operation of the user interface is disabled. In the switching step, the image processing system is set to the second mode by receiving a control command via the communication unit if the operation status is the first status, and if a predetermined operation is performed on the user interface in the first status, the operation status is switched from the first status to the second status and the image processing system is changed to the first mode by receiving a control command via the communication unit.

Further features and advantages of the present invention will become apparent from the following description of the embodiments (with reference to the attached drawings).

### BRIEF DESCRIPTION OF THE DRAWINGS

FIG. 1 is a diagram of a system to which the present invention is applied.

FIG. 2 is a functional block diagram of a computer in a system to which the present invention is applied.

FIG. 3 is a diagram showing a display screen of a digital camera when the camera is in the camera-operation mode according to an embodiment of the present invention.

FIG. 4 is a functional block diagram of a digital camera.

FIG. 5 is a diagram showing a display screen of an application.

FIG. 6 is a diagram showing a display screen of an application.

FIG. 7 is a flowchart showing the operation of a digital camera.

FIG. 8 is a flowchart showing the operation of an application.

FIG. 9 is a diagram showing a transfer image list.

FIG. 10 is a flowchart showing the operation of an application.

FIG. 11 is a flowchart showing the operation of an application.

FIG. 12 is a flowchart showing the operation of an application.

FIG. 13 is a flowchart showing the operation of a digital camera.

FIG. 14 is a flowchart showing the operation of an application.

### DETAILED DESCRIPTION OF THE EMBODIMENTS

Embodiments according to the present invention will now be described in detail with reference to the drawings.

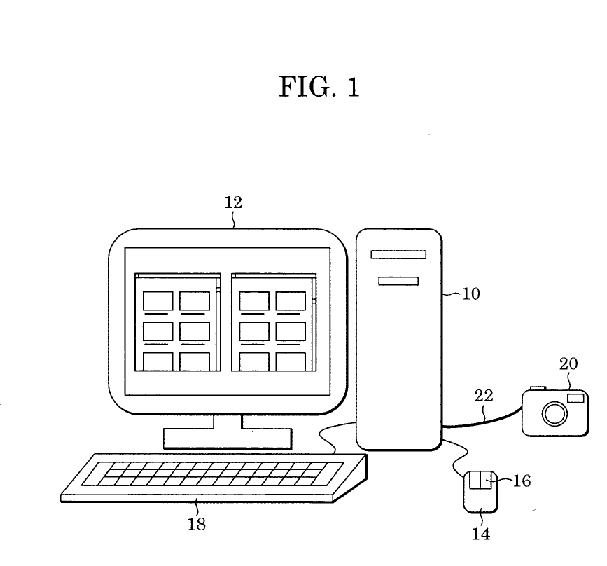

FIG. 1 is a diagram showing the structure of a system to which the present invention is applied.

Referring to FIG. 1, a computer 10, functioning as a host device, is connected to a monitor 12 for displaying an output from the computer 10 as an image, a mouse 14 including mouse buttons 16, and a keyboard 18. A digital camera 20 is connected to the computer 10 via a USB data transfer cable 22.

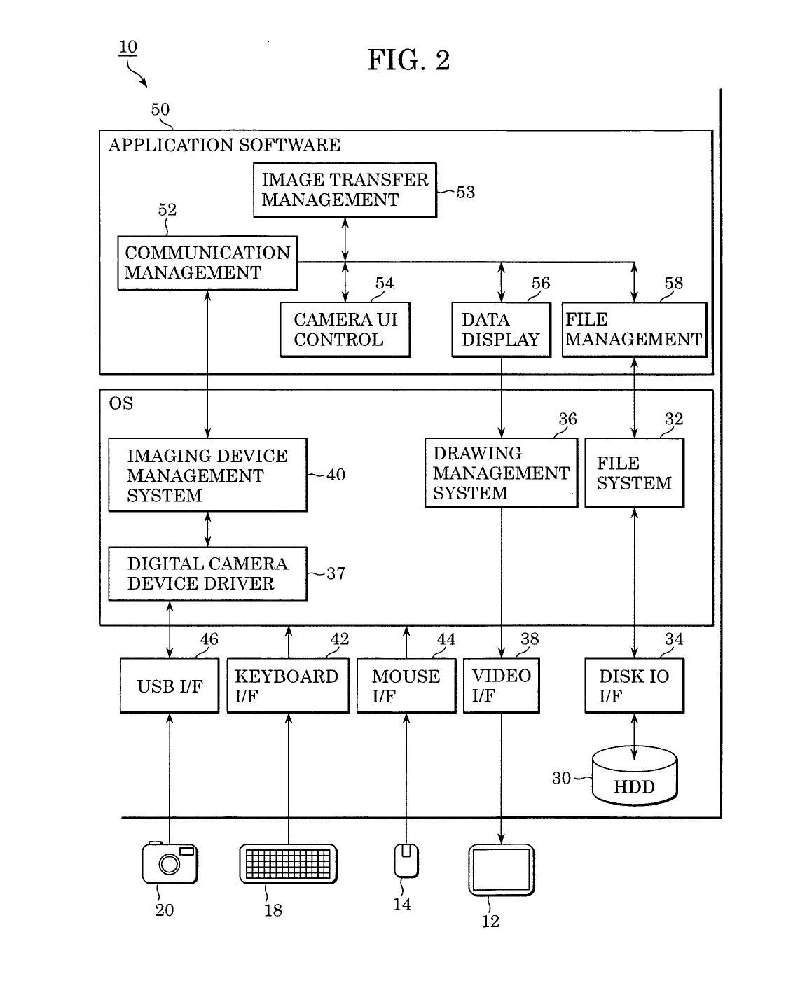

FIG. 2 is a functional block diagram of the computer 10 shown in FIG. 1.

As known to persons of ordinary skill in the art, the computer 10 has an operating system (OS) in the hardware, and application software 50 runs under the control of the operating system. Elements not required to understand the structure of the embodiment, such as the CPU and the memory management system of the operating system, are omitted.

The computer 10 includes a hard disk drive (HDD) 30, functioning as an auxiliary storage device. The operating system includes a file system 32 having a function for enabling files to be input/output without directly controlling the hardware by the application software 50. For the file system 32, a known structure can be used. The file system 32 reads and writes data from and to the hard disk 30 via a disk input/output interface 34.

The operating system further includes a drawing management system 36 having a function for generating an image without directly controlling the hardware by the application software 50. A video interface 38 converts image data generated in the drawing management system 36 into a video signal adapted for the monitor 12.

The operating system further includes an imaging device management system 40. The imaging device management system 40 manages a device for manipulating image data, such as a digital camera and a scanner. The imaging device management system 40 automatically allocates a device driver appropriate for a connected device, and furthermore, provides a mechanism for managing input to and output from the device without direct control of the device by the application software 50. In addition, the application software 50 can be started up at the request of the connected device.

The keyboard 18 is connected to a keyboard interface 42 and the mouse 14 is connected to a mouse interface 44. External devices, including the digital camera 20, are connected to a USB interface 46.

As described above, the digital camera 20 is connected to the USB interface 46 via the USB cable 22, and interchanges control commands, status signals, and image data with the application software 50 for the digital camera via a digital camera device driver 37 and the imaging device management system 40.

The application software 50 acquires images from the digital camera 20 and controls the digital camera 20. The application software 50 according to this embodiment includes a communication management unit 52 for communicating with the digital camera 20 by accessing the imaging device management system 40; an image transfer management unit 53 for acquiring an image captured in the digital camera 20 by using the communication management unit 52; a camera UI control unit 54 for sending a control command to the digital camera 20, setting the mode of the display screen of the digital camera 20, and turning the UI ON/OFF by using the communication management unit 52; a data display unit 56 for displaying on the monitor 12 an image and other information transferred from the digital camera 20; and a file management unit 58 for storing image data transferred from the digital camera 20 in the hard disk 30 for data management. Elements not required to understand the structure of the embodiment are omitted.

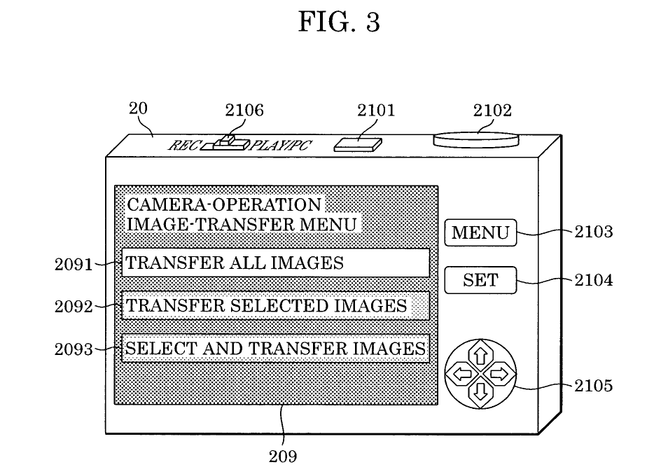

FIG. 3 is an external view of the digital camera 20.

A liquid crystal screen 209 displays various menus for specifying settings of the digital camera 20. The liquid crystal screen 209 is also used as a viewfinder for photography. Also, previously captured images can be played back on the liquid crystal screen 209 from the memory card.

A power button 2101 turns ON/OFF the power of the digital camera 20, and a photography/playback switching button 2106 switches between the photography mode and the playback mode of the digital camera 20. A shutter button 2102 is used to take a picture. A menu button 2103 is used to display a menu screen for setting the camera operation. When the menu button 2103 is operated, various menus are displayed on the liquid crystal screen 209. Items to be displayed in the menu differ depending on the mode of the digital camera 20. A set button 2104 and a move button 2105 are used to operate menus. More specifically, the move button 2105 is used to move from one selectable item to another and the set button 2104 is used to set the selected item. As described later, the menu button 2103 also has a function for switching to a camera operation mode while the digital camera 20 is connected to a PC.

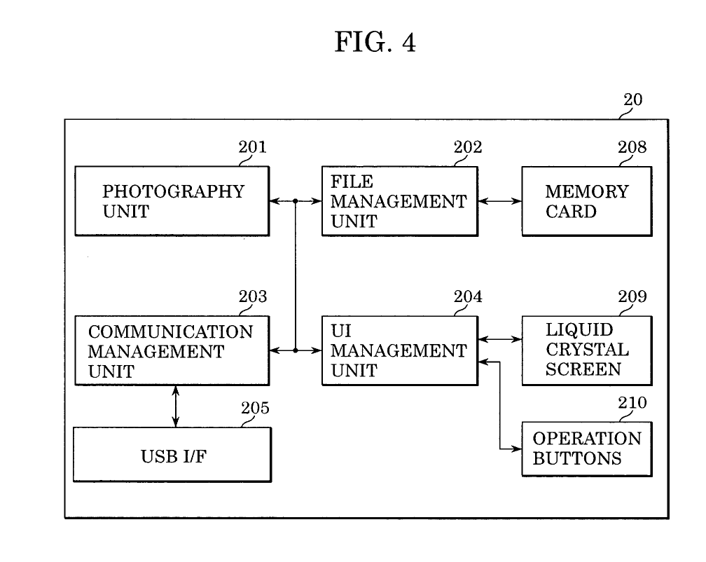

FIG. 4 is a functional block diagram of the digital camera 20.

Elements not required to understand the structure of the embodiment, such as the CPU and elements related to image playback, are omitted.

A photography unit 201 includes elements related to photography, such as a lens, an aperture, a CCD, and an image processor. A file management unit 202 manages access to a memory card 208, functioning as a storage device. According to this embodiment, a Compact Flash® (CF) card is used as the memory card 208. Image data generated by the photography unit 201 is stored in the memory card 208 as a file.

A communication management unit 203 communicates with the computer 10 via a USB interface 205.

The UI management unit 204 controls the UI of the digital camera 20 to manage display items on the liquid crystal screen 209. The UI management unit 204 also controls the UI of the digital camera 20 to manage inputs from operation buttons 210. The operation buttons 210 include the buttons 2101 to 2105 shown in FIG. 3.

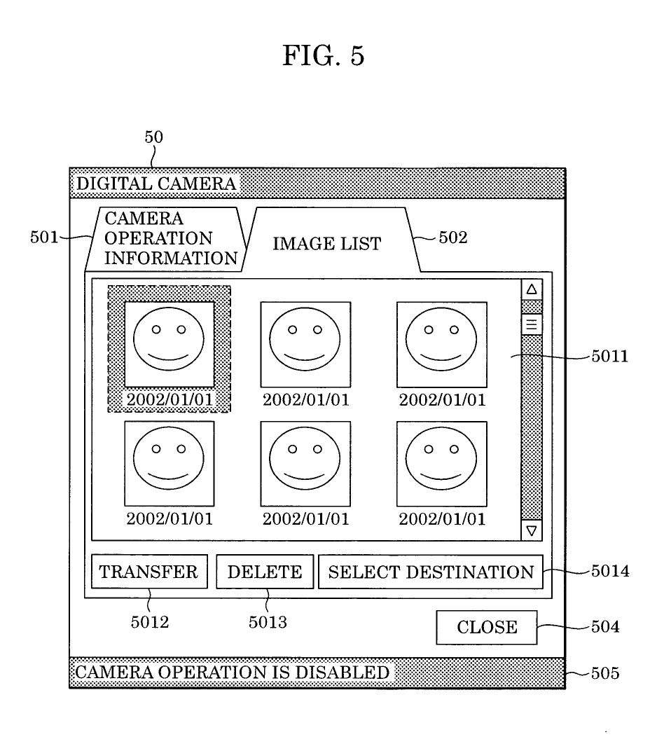

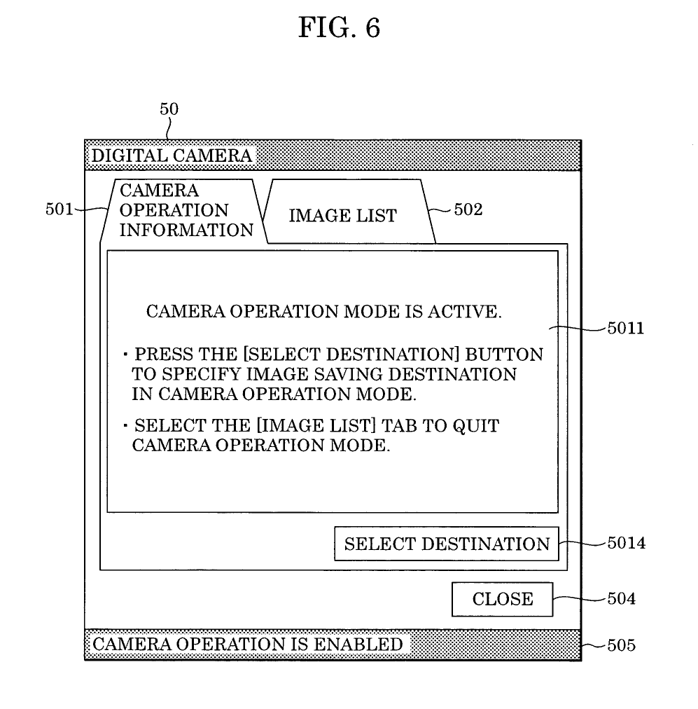

FIGS. 5 and 6 show a graphical user interface displayed on the monitor 12 by the application software 50 shown in FIG. 2.

The UI of the application 50 includes tabs for selecting functions, as shown in FIGS. 5 and 6, so that the UI changes by switching between the tabs.

The tabs include a camera-operation-information tab 501 and an image list tab 502. If the application 50 according to this embodiment is started up by the imaging device management system 40, the camera-operation-information tab 501 is selected initially, so that the screen shown in FIG. 6 appears. As described later, the startup of the application 50 by the imaging device management system 40 is automatically performed when the imaging device management system 40 senses that the digital camera 20 is connected to the PC 10.

In contrast, when the application 50 is started up by the user, the image list tab 502 is initially displayed, so that the screen shown in FIG. 5 appears.

When the camera-operation-information tab 501 in FIG. 6 is selected, a message indicating that the UI of the digital camera 20 is enabled is displayed in a camera mode display area 505. In this mode, the operation that can be performed with the application 50 is to specify an image transfer destination. An image transfer destination is a location in the computer, i.e., the location where an image file transferred from the digital camera 20 by operating the UI on the digital camera 20 is to be saved.

When the image list tab 502 shown in FIG. 5 is selected, reduced versions of images stored in the memory card 208 placed in the digital camera 20 are listed in an image list display area 5011.

While the application 50 is in this mode, the UI of the digital camera 20 is disabled, that is, the digital camera 20 cannot be operated. Thus, a message indicating that the UI of the digital camera 20 is disabled is displayed in the camera mode display area 505. In this mode, image data in the memory card 208 placed in the digital camera 20 can be transferred to the PC 10 by operating the application 50.

When image data stored in the memory card 208 is to be imported to the hard disk 30 of the PC 10, a desired image is selected from the reduced versions of images displayed in the image list display area 5011 and a [TRANSFER] button 5012 is then pressed. A transfer destination in the hard disk 30 can be specified with a [SELECT DESTINATION] button 5014. Furthermore, pressing a [DELETE] button 5013 causes the image file corresponding to the selected image to be deleted from the memory card 208 placed in the digital camera 20.

The digital camera 20 according to this embodiment has two modes of communication with the PC 10.

One mode is an application mode, in which the UI of the digital camera 20 is disabled; more specifically, nothing is displayed on the liquid crystal screen 209 of the camera 20, and the operation buttons 210 on the camera 20, except for the power button 2101 and the menu key 2103, are disabled.

The other of the two communication modes is a camera operation mode, in which the UI of the digital camera 20 is enabled; more specifically, a menu as shown in FIG. 3 is displayed on the liquid crystal screen 209 and the menu can be operated with the operation buttons 210.

According to this embodiment, while the digital camera 20 is in the camera operation mode, a camera-operation image-transfer menu, as shown in FIG. 3, is displayed on the liquid crystal screen 209 to allow the user to select one of the following three menu items.

A first menu item is a [TRANSFER ALL IMAGES] item 2091. When this item is selected, image data stored in the memory card 208 placed in the digital camera 20 can be all transferred to the host application 50.

A second menu item is a [TRANSFER SELECTED IMAGES] item 2092. When this item is selected, pre-selected image data is transferred to the computer 10.

A third menu item is a [SELECT AND TRANSFER IMAGES] item 2093. When this item is selected, image data stored in the memory card 208 are sequentially played back for display on the liquid crystal screen 209, so that desired images to be transferred to the computer 10 are selected from among the displayed images.

When the application 50 is running and the image list tab 502 is selected to list images stored in the memory card 208 placed in the digital camera 20, as shown in FIG. 5, the digital camera 20 is placed in the application mode, i.e., the mode in which the UI of the digital camera 20 is disabled. As a result, the digital camera 20 cannot be used to operate image data in the CF card 208. This prevents images displayed with the application 50 from differing from the images in the CF card 208 placed in the digital camera 20.

In other words, it is not necessary to perform processing for matching the information displayed by the application 50 to the content of the memory card 208 placed in the digital camera 20.

In contrast, when the digital camera 20 is in the camera-operation mode, the display screen of the application 50 appears as when the camera-operation-information tab 501 is selected, as shown in FIG. 6; in short, the content of the memory card 208 placed in the digital camera 20 is not displayed.

Therefore, the content of the memory card 208 placed in the camera 20 is prevented from being changed using the application 50 during image transfer in the camera-operation mode. More specifically, the problem of, for example, attempting to delete image data being transferred using a command from the PC 10 is eliminated.

Processing by the camera 20 and the application 50 for these operations will now be described with reference to flowcharts.

According to this embodiment, when the digital camera 20 is connected to the PC 10, the digital camera 20 is automatically placed into the camera-operation mode, displaying the menu shown in FIG. 3 on the liquid crystal screen 209. Furthermore, the digital camera 20 can be placed into the camera-operation mode by operating the menu button 2103 on the digital camera 20 and issuing an event indicating operation of the menu button 2103 to the PC 10 while the digital camera 20 is connected to the PC 10 in the above-described application mode. To perform desired processing, the user operates the move button 2105 on the digital camera 20 to move selection to the desired menu item and presses the set button 2104.

Furthermore, in this case, the imaging device management system 40 senses that the digital camera 20 is connected to the PC 10 to automatically startup the application 50. As a result of the application 50 being started up, the initial screen of the monitor 12 appears as when the camera-operation-information tab 501 is selected, as shown in FIG. 6. If the application 50 has already been started up, the screen of the camera information tab 501 being selected automatically appears.

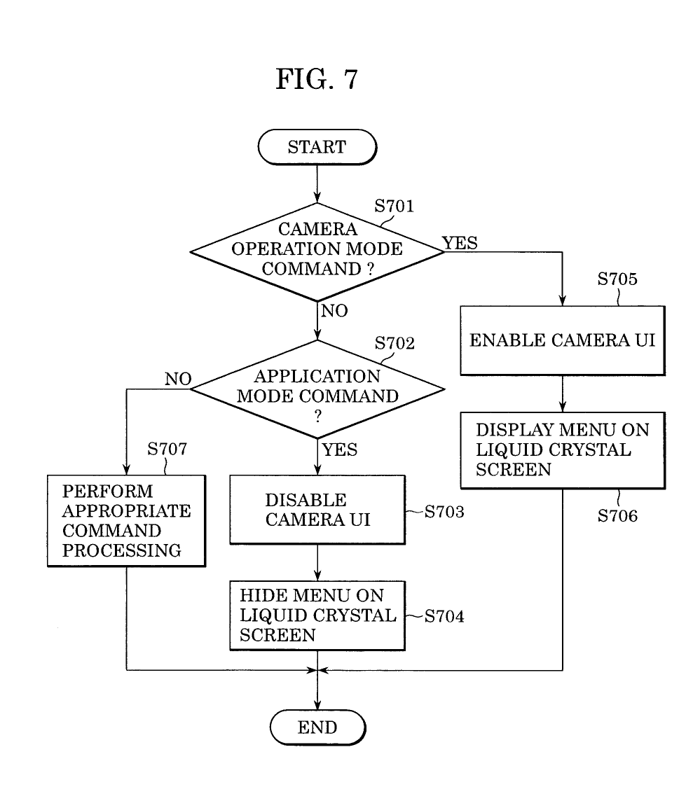

FIG. 7 is a flowchart for describing the operation of the command message processing routine for processing commands from the PC 10 in the digital camera 20.

First in step S701, a determination is made as to whether a command for entering the camera-operation mode has been issued as a result of the camera 20 being connected to the PC 10 or the menu button 2103 being operated while the digital camera 20 connected to the PC 10 is in the application mode. If a command for entering the camera-operation mode has been issued, in step S705 the camera buttons and the liquid crystal screen 209 are enabled by the UI management unit 204. Subsequently, in step S706, the menu screen shown in FIG. 3 is displayed on the liquid crystal screen 209.

If a command for entering the camera-operation mode has not been issued, then in step S702 it is determined whether a command for entering the application-mode has been issued. If a command for entering the application-mode has been issued, in steps S703 and S704 the camera buttons and the liquid crystal screen 209 are disabled by the UI management unit 204.

If neither a command for entering the camera-operation mode nor a command for entering the application-mode has been issued, in step S707 appropriate command processing is carried out. This processing includes, for example, transferring a transfer image list, to be described later, to the PC 10.

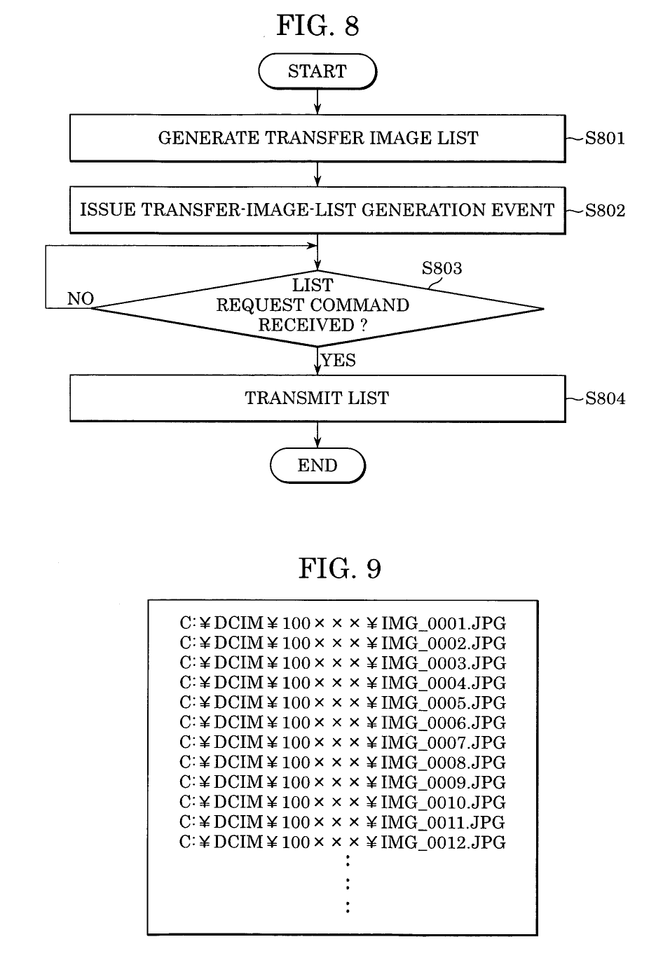

FIG. 8 is a flowchart showing the operation of the digital camera 20 when the set button 2104 is pressed to select one menu item while the digital camera 20 is in the camera-operation mode.

First, in step S801, a transfer image list which is a list of images to be transferred is generated. Images to be transferred differ depending on the item selected in the camera-operation image-transfer menu shown in FIG. 3. When the [TRANSFER ALL IMAGES] item 2091 is selected, a transfer image list containing all images stored in the memory card 208 is generated. When the [TRANSFER SELECTED IMAGES] item 2092 is selected, a transfer image list is generated according to a pre-generated image transfer list.

The image transfer list used in this specification is based on the Digital Print Order Format (DPOF) commonly used in digital cameras. The content of the list and how to select the list are not directly related to the present invention, and will not be described.

When the [SELECT AND TRANSFER IMAGES] item 2093 is selected, images stored in the memory card 208 are sequentially read and displayed on the liquid crystal screen 209, so that the user can select images to be transferred from among those sequentially displayed images.

The image display method is not directly related to the present invention, and thus will not be described. Regardless of which item has been selected, the generated transfer image list contains paths to image files in the memory card 208, as shown in FIG. 9. The format of the list is not directly related to the present invention, and any format can be employed for the list.

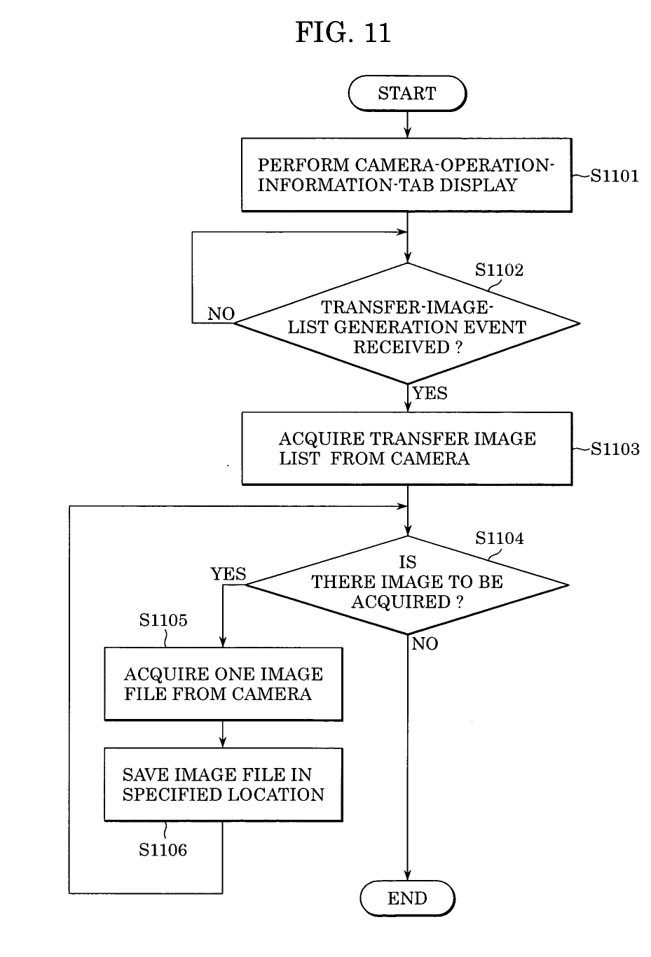

Next in step S802, a transfer-image-list generation event is issued to the application 50. This informs the application 50 that a transfer image list has been generated. At this point, the application 50 will request the transfer image list from the camera. Thus, a command from the application 50 that requests the transfer image list is awaited in step S803. On receiving the transfer-image-list generation event, the application 50 then issues the command to the camera 20 to acquire the list. In this manner, this list can by synchronized or compared with images currently stored on the PC 10 to maintain data consistency as further described with reference to FIG. 11.

When a request is made for the transfer image list, in step S804 the transfer image list generated in step S801 is transferred to the application 50.

The operation of the application software 50 will now be described.

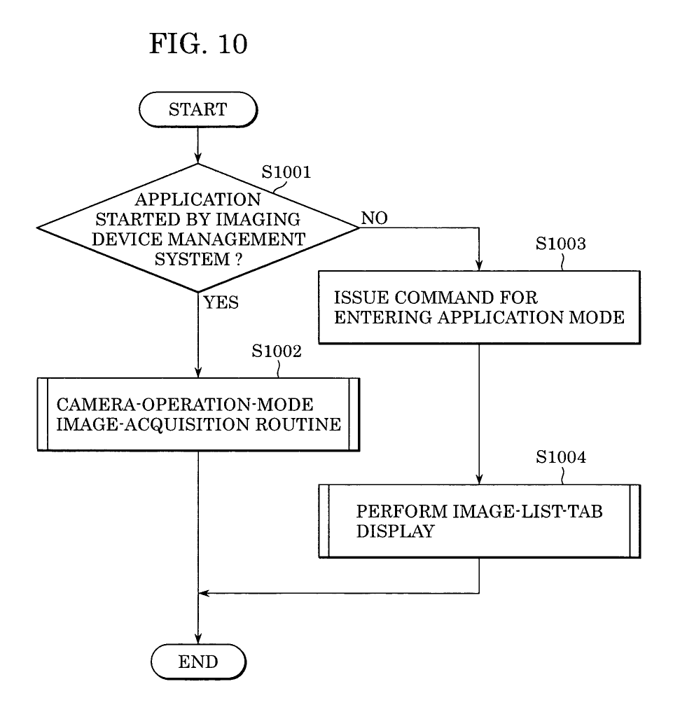

FIG. 10 is a flowchart for describing the processing when the application software 50 is started up.

First in step S1001, it is determined whether the application 50 has been started up by the user or by the imaging device management system 40.

If a determination is made that the application 50 has been started up from the imaging device management system 40, it means that the digital camera 20 has been connected to the PC 10 or the menu button 2103 on the digital camera 20 has been pressed, and the process proceeds to step S1002.

In step S1002, image data is acquired in the camera-operation mode. Image acquisition in the camera-operation mode will be described later.

On the other hand, if a determination is made that the application 50 has not been started up from the imaging device management system 40, in step S1003 a command for entering the application mode is issued to the camera 20 to disable the UI of the camera 20. Then in step S1004, image data is acquired from the camera 20 to display the image data in the format shown in FIG. 5. The image acquisition method is not directly related to the present invention, and thus will not be described.

FIG. 11 shows a flowchart for describing the operation for image acquisition by the application 50 in the camera-operation mode. First in step S1101, the screen appearing when the camera-operation-information-tab 501 is selected, as shown in FIG. 6, is displayed on the monitor 12. Then in step S1102, a transfer-image-list generation event from the camera 20 is awaited.

On receiving a transfer image generation event, in step S1103 a command for requesting a transfer image list is issued to the camera 20 to acquire the transfer image list. The description of processing for acquiring one image data item at a time from the transfer image list follows.

In step S1104, the acquired transfer image list is analyzed to determine whether an image that has not yet been acquired exists in the list. If the list contains an image that has not yet been acquired, in step S1105 one image file contained in the transfer image list is acquired from the digital camera 20. The acquisition method is not directly related to the present invention, and will not be described. The acquired image data is then saved in a predetermined location in the hard disk 30. The saving destination can be changed with the [SELECT DESTINATION] button 5014 on the camera operation information screen shown in FIG. 6.

On the other hand, if a determination is made that the list does not contain an image to be acquired, i.e., that all images described in the transfer image list have been acquired, the processing ends. In this manner, data consistency is maintained between the camera 20 and the PC 10 since images that were previously acquired are not reacquired and unnecessary duplication of images is avoided.

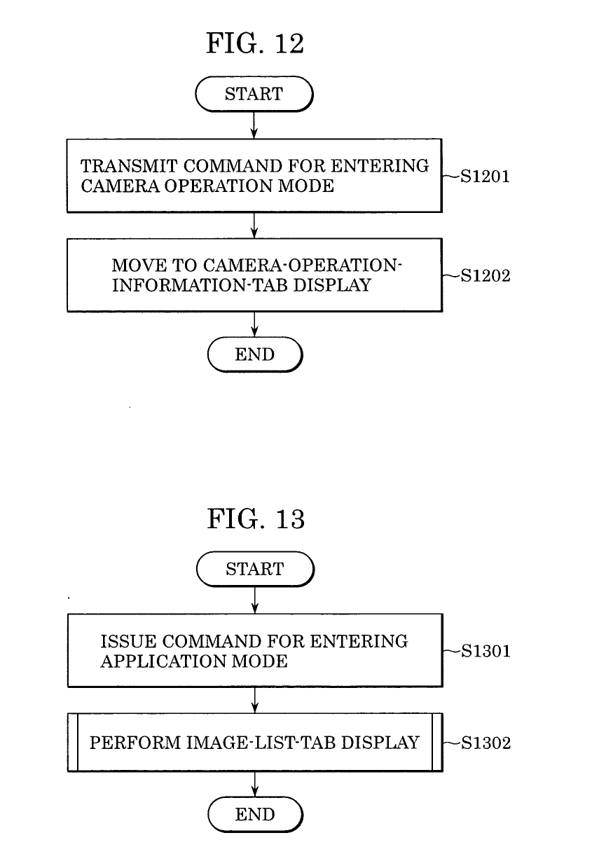

The operation triggered as a result of the camera-operation-information tab 501 being selected after the image list tab 502 has been selected (after start up of application 50) will be described with reference to the flowchart of FIG. 12.

First in step S1201, a command for entering the camera operation mode is issued to the digital camera 20. As described above, the camera 20 enables its UI on receiving this command. Then in step S1202, the screen appearing when the camera-operation-information tab 501 is selected, as shown in FIG. 6, is displayed on the monitor 12.

The operation triggered as a result of the image list tab 502 being selected after the camera-operation-information tab 501 has been selected will be described with reference to the flowchart of FIG. 13.

In step S1301, a command for entering the application mode is issued to the camera 20. As described above, on receiving this command, the camera 20 disables its UI to reject camera operation by the user. Then in step S1302, the display screen of the monitor 12 changes to the screen appearing when the image list tab 502 is selected, as shown in FIG. 5. To display the image list tab 502, images need to have been acquired in the camera 20. This operation is not directly related to the present invention, and will not be described.

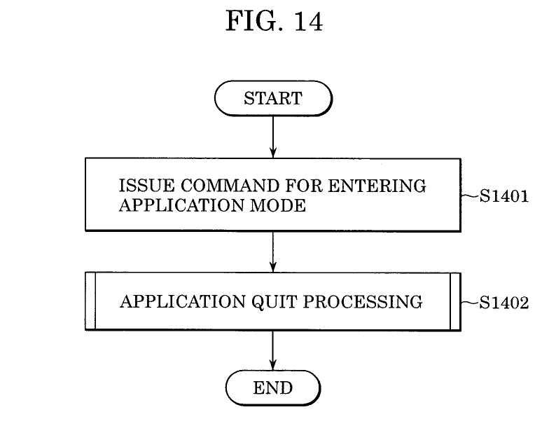

The processing for quitting the application 50 will now be described with reference to the flowchart in FIG. 14.

First in step S1401, a command for entering the application mode is issued to the camera 20. This is performed because processing in the camera-operation mode cannot be performed after the application 50 is terminated. Finally, in step S1402 the application 50 ends.

As described above, according to this embodiment, the two modes of the digital camera are switched in conjunction with the mode of the host application. Thus, when the application on the PC is used to display images stored in the memory card placed in the digital camera, the UI of the camera is disabled to prevent images from being deleted unintentionally by operating the digital camera.

In addition, when the digital camera is used to operate images stored in the memory card, the images are not displayed with the application to prevent the images from being operated with the application. This eliminates the need for tracking the result of image processing on the PC.

Furthermore, when the camera is in the application mode, both the camera and the PC can be placed into the camera-operation mode by operating the menu key, so that a simple procedure for transferring images by using the camera is provided. Thus, the user does not need to switch the PC mode each time the user attempts to transfer images via camera operation.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-419360 filed Dec. 17, 2003, which is hereby incorporated by reference herein.

1. An image processing system comprising:
a playback unit for playing back an image recorded on a recording medium;
a communication unit for transmitting the image played back by the playback unit to an external information processing system via a transmission pathway;
an operation unit including a plurality of operation keys; and
a control unit for switching between a first transmission mode in which transmission of the image according to an operation of the operation unit is enabled and a second transmission mode in which transmission of the image according to an operation of the operation unit is disabled,
wherein the control unit changes the transmission mode to the first transmission mode according to a predetermined operation of the operation unit in the second transmission mode.

2. The image processing system according to claim 1, further comprising:
a display unit for displaying a plurality of items associated with transmission of the image by the communication unit,
wherein the operation unit includes a selection key for selecting an image to be transmitted from among a plurality of images recorded on the recording medium and a menu key for specifying the display of the plurality of items, and the control unit changes the transmission mode to the first transmission mode as a result of the menu key being operated in the second transmission mode to display the plurality of items on the display unit.

3. The image processing system according to claim 2, wherein the image is transmitted in the first transmission mode according to the item selected by operating the selection key, and the display of the plurality of items by the display unit is disabled in the second transmission mode.

4. The image processing system according to claim 2, wherein if the menu key is operated in the second transmission mode, the control unit transmits event information indicating the operation of the menu key to the information processing system via the communication unit.

5. The image processing system according to claim 1, wherein the information processing system has a first status in which an image recorded on the recording medium can be changed and a second status in which the image recorded on the recording medium cannot be changed, and the control unit transmits, to the information processing system via the communication unit, predetermined information for switching the status of the information processing system from the first status to the second status according to the predetermined operation in the second transmission mode.

6. The image processing system according to claim 1, further comprising:
an imaging unit; and
a recording unit for recording an image acquired by the imaging unit on the recording medium.

7. An image processing system comprising:
an imaging system having a first mode in which transmission of an image recorded on a recording medium by an operation of an operation unit is enabled and a second mode in which transmission of the image by an operation of the operation unit is disabled, and capable of transmitting an image recorded on the recording medium via a transmission pathway; and
a computer connected to the imaging system via the transmission pathway, the computer receiving the transmitted image to display the transmitted image on a display device and the computer having a first status in which processing of the image recorded on the recording medium by operating a user interface is enabled and a second status in which processing of the image by operating the user interface is disabled,
wherein if a predetermined operation is performed by the operation unit while the imaging system is in the second mode and the computer is in the first status, the imaging system switches from the second mode to the first mode and the computer switches from the first status to the second status.

8. A data processing system comprising:
a communication unit for receiving an image on a recording medium via a transmission pathway, the image being played back by an external image processing system having a first mode in which transmission of the image according to an operation of an operation unit is enabled and a second mode in which transmission of the image according to an operation of the operation unit is disabled;
a display unit for displaying the image on a display device, the image being received via the communication unit;
a user interface for specifying processing of the image recorded on the recording medium; and
a control unit for switching an operation status between a first status in which processing of the image recorded on the recording medium by an operation of the user interface is enabled and a second status in which processing of the image according to an operation of the user interface is disabled,
wherein the control unit sets the image processing system to the second mode by transmitting a control command via the communication unit if the operation status is the first status, and the control unit switches the operation status from the first status to the second status and changes the image processing system to the first mode by outputting a control command to the image processing system via the communication unit if a predetermined operation is performed on the user interface in the first status.

9. The data processing system according to claim 8, wherein, in the second status, the control unit controls the display unit such that the display unit displays information indicating that a command for processing the image via the user interface is overridden.

10. A data processing method comprising the steps of:
displaying an image on a display device, the image being received by a communication unit for receiving the image on a recording medium via a transmission pathway, the image being played back by an external image processing system having a first mode in which transmission of the image according to an operation of an operation unit is enabled and a second mode in which transmission of the image according to an operation of the operation unit is disabled; and
switching an operation status between a first status in which processing of the image recorded on the recording medium by an operation of a user interface for specifying processing of the image recorded on the recording medium is enabled and a second status in which processing of the image according to an operation of the user interface is disabled,
wherein, in the switching step, the image processing system is set to the second mode by receiving a control command via the communication unit if the operation status is the first status, and if a predetermined operation is performed on the user interface in the first status, the operation status is switched from the first status to the second status and the image processing system is changed to the first mode by receiving a control command via the communication unit.
